(19) United States
(12) Patent Application Publication
(10) Pub. No.: US 2026/0082353 A1
(43) Pub. Date: Mar. 19, 2026

(54) WIRELESS COMMUNICATION TERMINAL, BASE STATION, AND WIRELESS COMMUNICATION SYSTEM

(71) Applicant: SONY SEMICONDUCTOR SOLUTIONS CORPORATION, KANAGAWA (JP)

(72) Inventors: HIDESHI MOTOYAMA, KANAGAWA (JP); KAZUYA NAKAMURA, KANAGAWA (JP)

(21) Appl. No.: 19/106,240

(22) PCT Filed: Jul. 13, 2023
(86) PCT No.: PCT/JP2023/025876

§ 371 Date: Feb. 25, 2025

(30) Foreign Application Priority Data
Sep. 6, 2022 (JP) 2022-141650

(51) Int. Cl. H04W 64/00; H04W 52/02

(52) U.S. Cl. CPC H04W 64/00; H04W 52/0209

(57) ABSTRACT

To reduce power consumption of a wireless communication terminal at the time of positioning processing. A wireless communication terminal includes: a wireless communication unit that performs wireless communication; a positioning processing unit that performs positioning processing on the basis of reception data received via the wireless communication unit; and a control unit that controls power consumption related to the positioning processing on the basis of control information regarding the positioning processing acquired via the wireless communication unit. The wireless communication terminal further includes an amplifier that amplifies a signal received via an antenna, in which the wireless communication unit transmits position information obtained by the positioning processing unit, and the control unit controls an operation of the amplifier on the basis of control information regarding the positioning processing obtained via the wireless communication unit.

### TECHNICAL FIELD

The present technology relates to a wireless communication terminal, a base station, and a wireless communication system. Specifically, the present technology relates to a wireless communication terminal, a base station, and a wireless communication system having a positioning function.

### BACKGROUND ART

In a wireless communication terminal, a positioning function may be mounted in order to acquire position information. Depending on the application in which the wireless communication terminal is used, the non-charging period may be long, and low power consumption at the time of positioning processing is required. As such a technique, for example, there is a technique in which the control device invalidates the amplifier when positioning can be performed by a positioning device, and the control device validates the amplifier when positioning cannot be performed by the positioning device (see, for example, Patent Document 1).

### CITATION LIST

### Patent Document

Patent Document 1: U.S. Patent Application Publication No. 2015/0145725

### SUMMARY OF THE INVENTION

### Problems to be Solved by the Invention

However, in the conventional technique described above, the amplifier is always enabled at the time of positioning processing for determining invalidation of the amplifier, and there has been a possibility of causing an increase in power consumption. In addition, in the conventional technique described above, since the amplifier is enabled after the positioning cannot be performed, there is a possibility that the power consumption for coping with the inability to perform positioning may increase.

The present technology has been made in view of such a situation, and an object thereof is to reduce power consumption of a wireless communication terminal at the time of positioning processing.

### Solutions to Problems

The present technology has been made to solve the problems described above, and a first aspect thereof is a wireless communication terminal including: a wireless communication unit that performs wireless communication; a positioning processing unit that performs positioning processing on the basis of reception data received via the wireless communication unit; and a control unit that controls power consumption related to the positioning processing on the basis of control information regarding the positioning processing acquired via the wireless communication unit. This brings about an effect that the power consumption related to the positioning processing of the wireless communication terminal is controlled without the wireless communication terminal determining the control of the power consumption related to the positioning processing.

Furthermore, in the first aspect, the wireless communication terminal further includes an amplifier that amplifies a signal received via an antenna, in which the wireless communication unit transmits position information obtained by the positioning processing unit, and the control unit controls an operation of the amplifier on the basis of control information regarding the positioning processing obtained via the wireless communication unit. This brings about an effect that the power consumption of the amplifier is controlled without the wireless communication terminal determining the control of the operation of the amplifier that amplifies the reception data.

Furthermore, in the first aspect, the wireless communication unit may transmit reception strength together with position information obtained by the positioning processing unit. This brings about an effect that the power consumption related to the positioning processing is controlled on the basis of the reception strength of the wireless communication terminal.

Furthermore, in the first aspect, the control information may include a signal for turning on or off the amplifier. This brings about an effect that on/off of the amplifier of the wireless communication terminal is controlled without the wireless communication terminal determining on/off of the amplifier.

Furthermore, in the first aspect, the wireless communication unit includes: a first wireless communication unit that performs wireless communication related to the positioning processing; and a second wireless communication unit that performs wireless communication related to control of the power consumption. This brings about an effect that wireless communication related to power consumption control is performed separately from wireless communication related to positioning processing of a wireless communication terminal.

Furthermore, in the first aspect, the first wireless communication unit performs wireless communication using a global navigation satellite system (GNSS), and the second wireless communication unit performs wireless communication using at least one of low power wide area (LPWA), WiFi, BlueTooth, Bluetooth low energy (BLE), or cellular communication. This brings about an effect of ensuring flexibility of wireless communication related to control of power consumption while ensuring wide area of positioning of the wireless communication terminal.

Furthermore, in the first aspect, the positioning processing unit performs positioning processing on the basis of a signal using at least one of GNSS, LPWA, WiFi, BlueTooth, BLE, cellular communication, received signal strength, or an arrival angle. This brings about an effect that wireless communication related to power consumption control is flexibly performed according to the situation of the wireless communication terminal on the spot.

Furthermore, in the first aspect, the control information includes information regarding a position accuracy setting. As a result, there is an effect that the power consumption related to the positioning processing is controlled on the basis of the position accuracy setting of the wireless communication terminal.

Furthermore, in the first aspect, the control unit may set an operation of the positioning processing unit to on or off on the basis of the information regarding the position accuracy setting. This brings about an effect that the power consumption of the positioning processing unit is controlled on the basis of the position accuracy setting of the wireless communication terminal.

Furthermore, in the first aspect, the position accuracy may be set on the basis of at least one of external designation, scheduling, position information, an application, or a contract form. With this configuration, it is possible to achieve a setting of the position accuracy of the wireless communication terminal.

Furthermore, a second aspect is a base station including: a wireless communication unit that performs wireless communication; and a communication processing unit that performs communication processing of control information for controlling power consumption related to positioning processing. This brings about an effect that power consumption related to positioning processing of the wireless communication terminal is controlled on the basis of an instruction from the base station.

Furthermore, in the second aspect, the base station further includes: a reception strength prediction unit that predicts reception strength around the communication destination on the basis of position information of the communication destination; and a first control information generation unit that generates the control information on the basis of the reception strength around the communication destination. This brings about an effect that power consumption related to positioning processing of the wireless communication terminal is controlled on the basis of an instruction from the base station based on reception strength around the wireless communication terminal.

Furthermore, in the second aspect, the base station may further include a table indicating a relationship between position information of the communication destination and reception strength around the communication destination. This brings about an effect that the reception strength around the wireless communication terminal is determined from the position information of the wireless communication terminal.

Furthermore, in the second aspect, the wireless communication unit may perform wireless communication using at least one of LPWA, WiFi, BlueTooth, BLE, or cellular communication. This brings about an effect that wireless communication related to power consumption control is flexibly performed according to the situation of the wireless communication terminal on the spot.

Furthermore, in the second aspect, the base station may further include: a position accuracy setting unit that sets position accuracy of a communication destination; and a second control information generation unit that generates the control information on the basis of the position accuracy setting of the communication destination. This brings about an effect that power consumption related to positioning processing of the wireless communication terminal is controlled on the basis of an instruction from the base station based on the position accuracy setting of the wireless communication terminal.

Furthermore, in the second aspect, the position accuracy setting unit may set the position accuracy on the basis of at least one of external designation, scheduling, position information, an application, or a contract form. With this configuration, it is possible to achieve a setting of the position accuracy of the wireless communication terminal.

Furthermore, a third aspect is a wireless communication system including: a base station that transmits control information for controlling power consumption related to positioning processing; and a wireless communication terminal that controls power consumption related to the positioning processing on the basis of the control information transmitted from the base station. This brings about an effect that the power consumption related to the positioning processing of the wireless communication terminal is controlled without the wireless communication terminal determining the control of the power consumption related to the positioning processing.

Furthermore, in the third aspect, the base station may predict reception strength around the wireless communication terminal on the basis of position information of the wireless communication terminal, generate control information for controlling power consumption related to positioning processing of the wireless communication terminal on the basis of reception strength around the wireless communication terminal, and transmit the generated control information to the wireless communication terminal, and the wireless communication terminal may transmit position information of the wireless communication terminal to the base station, receive the control information transmitted from the base station, and control an operation of an amplifier for amplifying reception data related to the positioning processing on the basis of the control information. This brings about an effect that on/off of the amplifier of the wireless communication terminal is controlled without the wireless communication terminal determining on/off of the amplifier.

Furthermore, in the third aspect, the base station may set position accuracy of the wireless communication terminal, generate control information for controlling power consumption related to positioning processing of the wireless communication terminal on the basis of the position accuracy setting of the wireless communication terminal, and transmit the generated control information to the wireless communication terminal, and the wireless communication terminal may receive the control information transmitted from the base station, and set operation of the positioning processing to on or off on the basis of the control information. This brings about an effect that power consumption related to positioning processing of the wireless communication terminal is controlled on the basis of an instruction from the base station based on the position accuracy setting of the wireless communication terminal.

Furthermore, in the third aspect, the wireless communication terminal may perform wireless communication using GNSS, and the wireless communication terminal and the base station may perform wireless communication using at least one of LPWA, WiFi, BlueTooth, BLE, or cellular communication. This brings about an effect of ensuring flexibility of wireless communication related to control of power consumption while ensuring wide area of positioning of the wireless communication terminal.

### BRIEF DESCRIPTION OF DRAWINGS

FIG. 1 is a block diagram illustrating a functional configuration example of a wireless communication system according to a first embodiment.

FIG. 2 is a diagram illustrating a relationship between a peripheral area and reception strength during movement of the wireless communication terminal according to the first embodiment.

FIG. 3 is a block diagram illustrating a hardware configuration example of the wireless communication terminal according to the first embodiment.

FIG. 4 is a block diagram illustrating a hardware configuration example of a base station according to the first embodiment.

FIG. 5 is a flowchart illustrating an operation example of the wireless communication terminal according to the first embodiment.

FIG. 6 is a flowchart illustrating an operation example of the base station according to the first embodiment.

FIG. 7 is a block diagram illustrating a functional configuration example of a wireless communication system according to a second embodiment.

FIG. 8 is a block diagram illustrating a functional configuration example of a wireless communication system according to a third embodiment.

FIG. 9 is a block diagram illustrating a functional configuration example of a wireless communication system according to a fourth embodiment.

FIG. 10 is a block diagram illustrating a hardware configuration example of a wireless communication terminal according to the fourth embodiment.

FIG. 11 is a block diagram illustrating a hardware configuration example of a base station according to the fourth embodiment.

FIG. 12 is a flowchart illustrating an operation example of the wireless communication terminal according to the fourth embodiment.

FIG. 13 is a flowchart illustrating an operation example of the base station according to the fourth embodiment.

FIG. 14 is a block diagram illustrating a functional configuration example of a wireless communication system according to a fifth embodiment.

FIG. 15 is a block diagram illustrating a functional configuration example of a wireless communication system according to a sixth embodiment.

FIG. 16 is a block diagram illustrating a functional configuration example of a wireless communication system according to a seventh embodiment.

### MODE FOR CARRYING OUT THE INVENTION

Modes for carrying out the present technology (hereinafter, referred to as embodiments) will be described below. The description will be given in the following order.
1. First Embodiment (example in which positioning is performed on the basis of communication using GNSS, and an operation of an amplifier of a wireless communication terminal is controlled in accordance with an instruction from a base station based on reception strength of a peripheral area of the wireless communication terminal)
2. Second Embodiment (example of performing positioning on the basis of communication with a first base station and controlling an operation of an amplifier of a wireless communication terminal in accordance with an instruction from a second base station based on reception strength of a peripheral area of the wireless communication terminal)
3. Third Embodiment (example of performing positioning on the basis of communication with a base station and controlling an operation of an amplifier of a wireless communication terminal in accordance with an instruction from the base station based on reception strength of a peripheral area of the wireless communication terminal)
4. Fourth Embodiment (example of performing positioning on the basis of communication using GNSS and controlling positioning of a wireless communication terminal in accordance with an instruction from a base station based on a position accuracy setting of the wireless communication terminal)
5. Fifth Embodiment (example of performing communication for performing positioning with a first base station and controlling positioning of a wireless communication terminal in accordance with an instruction from a second base station based on a position accuracy setting of the wireless communication terminal)
6. Sixth Embodiment (example of performing communication for performing positioning with a base station and controlling positioning of a wireless communication terminal in accordance with an instruction from the base station based on a position accuracy setting of the wireless communication terminal)
7. Seventh Embodiment (example of performing communication with GNSS and controlling positioning of a wireless communication terminal on the basis of a position accuracy setting of the wireless communication terminal)

### 1. First Embodiment

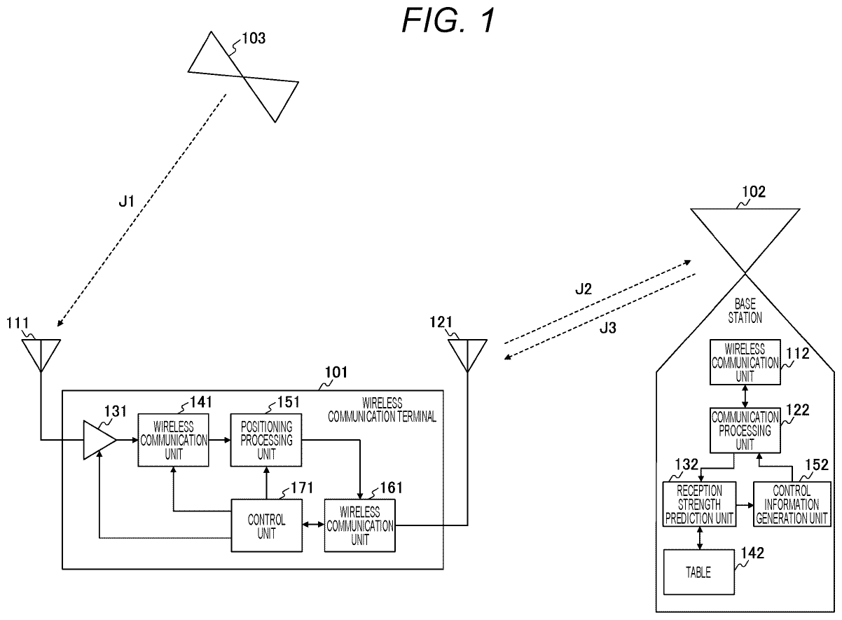

FIG. 1 is a block diagram illustrating a functional configuration example of a wireless communication system according to a first embodiment.

In the drawing, the wireless communication system includes a wireless communication terminal 101 and a base station 102.

The wireless communication terminal 101 performs wireless communication with a GNSS satellite 103, and performs positioning processing on the basis of reception data via the wireless communication. In addition, the wireless communication terminal 101 can perform wireless communication with the base station 102, receive control information for controlling power consumption related to positioning processing, and control power consumption related to positioning processing on the basis of the control information. The wireless communication terminal 101 may be a mobile terminal such as a smartphone, may be fixed to a mobile body used in Internet of Things (IoT) or the like and used, or may be used as a positioning device. The wireless communication terminal 101 may be an ELTRES terminal corresponding to ELTRES.

The wireless communication terminal 101 includes antennas 111 and 121, an amplifier 131, wireless communication units 141 and 161, a positioning processing unit 151, and a control unit 171.

The antenna 111 receives a signal transmitted from the GNSS satellite 103. The antenna 121 transmits and receives a signal used for communication with the base station 102. Note that a transmission antenna and a reception antenna may be separately provided in order to perform communication with the base station 102. The amplifier 131 amplifies the signal received via the antenna 111. The amplifier 131 may be a low noise amplifier (LNA).

The wireless communication unit 141 performs wireless communication with the GNSS satellite 103. At this time, the wireless communication unit 141 extracts reception data used for positioning from the signal amplified by the amplifier 131, and outputs the reception data to the positioning processing unit 151.

The positioning processing unit 151 performs positioning processing on the basis of the reception data received via the wireless communication unit 141. In this positioning processing, the current position of the wireless communication terminal 101 is calculated. At this time, the positioning processing unit 151 can perform positioning calculation using the GNSS time information and the orbit information. Note that, in a case where a positioning sensor such as an acceleration sensor, a gyro sensor, or a magnetic sensor is mounted on the wireless communication terminal 101, the positioning processing unit 151 may perform positioning by combining these pieces of data.

The wireless communication unit 161 performs wireless communication with the base station 102, and transmits position information of the wireless communication terminal 101 to the base station 102. The wireless communication unit 161 may transmit the reception strength together with the position information of the wireless communication terminal 101 obtained by the positioning processing unit 151. In addition, the wireless communication unit 161 can receive, from the base station 102, control information for controlling power consumption related to positioning processing of the wireless communication terminal 101. The control information can include a signal for turning on or off the amplifier 131. At this time, the wireless communication unit 161 can support wireless communication using at least one of LPWA, WiFi, BlueTooth, BLE, or cellular communication.

The control unit 171 controls operations of the amplifier 131, the wireless communication unit 141, and the positioning processing unit 151. At this time, the control unit 171 can control the operation of the amplifier 131 on the basis of the control information regarding the positioning processing of the wireless communication terminal 101 transmitted from the base station 102. For example, in a case where the base station 102 instructs the control unit 171 to turn on the amplifier 131, the control unit 171 can turn on the amplifier 131 at the time of positioning. Furthermore, in a case where the base station 102 instructs the control unit 171 to turn off the amplifier 131, the control unit 171 can turn off the amplifier 131 at the time of positioning.

The base station 102 performs wireless communication with the wireless communication terminal 101. Furthermore, the base station 102 can generate control information for controlling power consumption related to positioning processing of the wireless communication terminal 101 and transmit the control information to the wireless communication terminal 101. The base station 102 may perform wireless communication using at least one of LPWA, WiFi, BlueTooth, BLE, or cellular communication.

The base station 102 includes a wireless communication unit 112, a communication processing unit 122, a reception strength prediction unit 132, a table 142, and a control information generation unit 152.

The wireless communication unit 112 performs wireless communication with the wireless communication terminal 101, and transmits control information for controlling power consumption related to positioning processing of the wireless communication terminal 101 to the wireless communication terminal 101. At this time, the wireless communication unit 112 can support wireless communication using at least one of LPWA, WiFi, BlueTooth, BLE, or cellular communication.

The communication processing unit 122 performs communication processing of control information for controlling power consumption related to positioning processing. For example, the communication processing unit 122 can format or packetize the control information transmitted to the wireless communication terminal 101 so as to support the wireless communication method used by the wireless communication unit 112.

The reception strength prediction unit 132 predicts the reception strength around the wireless communication terminal 101 on the basis of the position information of the wireless communication terminal 101. The periphery of the wireless communication terminal 101 may be set within a predetermined range from the wireless communication terminal 101. For example, the periphery of the wireless communication terminal 101 may be set within a range of several tens of meters to several kilometers around the wireless communication terminal 101. The reception strength prediction unit 132 may refer to the table 142 in order to predict the reception strength around the wireless communication terminal 101.

The table 142 registers the relationship between the position information of the wireless communication terminal 101 and the reception strength around the wireless communication terminal 101. Note that the relationship between the position information of the wireless communication terminal 101 and the reception strength around the wireless communication terminal 101 may be not only the relationship in a case where the wireless communication terminal 101 is outdoors but also the relationship in a case where the wireless communication terminal 101 is indoors. The outdoors may be not only on the ground but also on the sea. Furthermore, the relationship between the position information of the wireless communication terminal 101 and the reception strength around the wireless communication terminal 101 is not limited to the relationship based on the distance from the wireless communication terminal 101, but may be a relationship in a case where there is an obstacle around the wireless communication terminal 101. The obstacles may include, for example, buildings, trees, tunnels, and underground spaces. Note that the base station 102 may not necessarily include the table 142. At this time, the reception strength prediction unit 132 may refer to the relationship between the position information of the wireless communication terminal 101 and the reception strength around the wireless communication terminal 101 via the network communicable with the base station 102. Note that the content of the table 142 may be updated on the basis of the position information and reception strength of the wireless communication terminal 101 transmitted from the wireless communication terminal 101.

The control information generation unit 152 generates control information for controlling power consumption related to positioning processing on the basis of the reception strength around the wireless communication terminal 101. This control information can include a signal for turning on or off the amplifier 131 of the wireless communication terminal 101.

When receiving the data transmitted from the GNSS satellite 103 (J1), the wireless communication terminal 101 performs positioning on the basis of the reception data, and transmits the position information of the wireless communication terminal 101 to the base station 102 (J2). The base station 102 predicts reception strength around the wireless communication terminal 101 on the basis of the position information of the wireless communication terminal 101. Then, the base station 102 generates control information instructing on/off of the amplifier 131 on the basis of the prediction result, and transmits the control information to the wireless communication terminal 101 (J3). The wireless communication terminal 101 turns on/off the amplifier 131 on the basis of the control information that is transmitted from the base station 102 and instructs on/off of the amplifier 131.

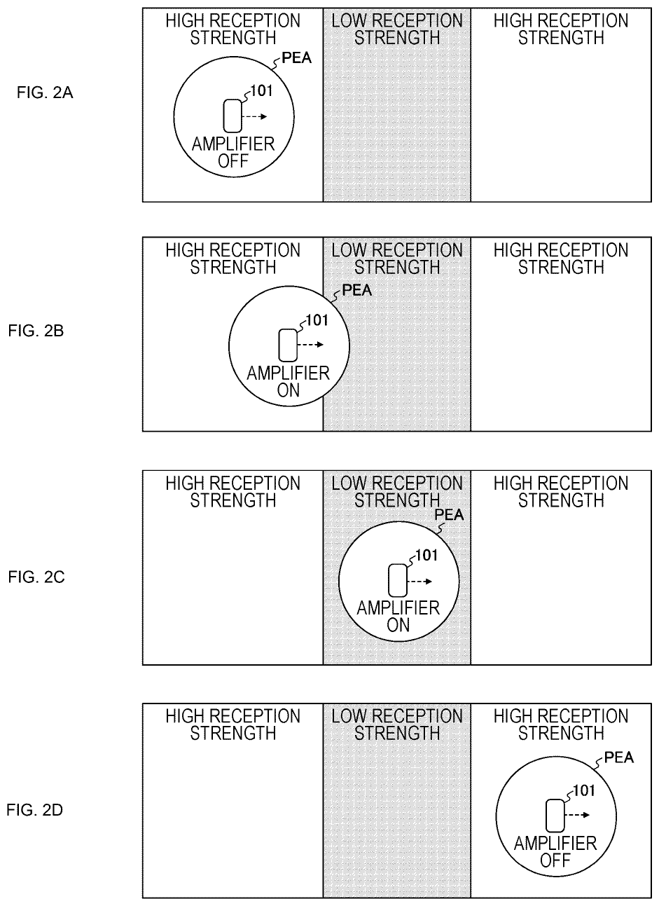

FIG. 2 is a diagram illustrating a relationship between a peripheral area and reception strength during movement of the wireless communication terminal according to the first embodiment. Note that a to d in the drawing illustrate an example in which the wireless communication terminal 101 crosses an area with low reception strength from an area with high reception strength and reaches the area with high reception strength.

In a of the drawing, the wireless communication terminal 101 performs positioning, and transmits position information of the wireless communication terminal 101 to the base station 102. At this time, it is assumed that the peripheral area PEA of the wireless communication terminal 101 is at a position with high reception strength. When receiving the position information of the wireless communication terminal 101, the base station 102 predicts the reception strength of the peripheral area PEA of the wireless communication terminal 101. At this time, when the base station 102 predicts that the reception strength of the peripheral area PEA of the wireless communication terminal 101 is high, the base station 102 transmits control information for turning off the amplifier 131 to the wireless communication terminal 101. When receiving the control information for turning off the amplifier 131, the wireless communication terminal 101 turns off the amplifier 131. In a case where the reception strength of the peripheral area PEA of the wireless communication terminal 101 is high, the wireless communication terminal 101 can perform positioning in a state where the amplifier 131 is turned off, and power consumption can be reduced.

Next, as illustrated in b of the drawing, the wireless communication terminal 101 performs positioning after movement, and transmits position information of the wireless communication terminal 101 to the base station 102. At this time, it is assumed that a part of the peripheral area PEA of the wireless communication terminal 101 has entered a position with low reception strength. When receiving the position information of the wireless communication terminal 101, the base station 102 predicts the reception strength of the peripheral area PEA of the wireless communication terminal 101. At this time, when the base station 102 predicts that a position with low reception strength is included in the peripheral area PEA of the wireless communication terminal 101, the base station 102 transmits control information for turning on the amplifier 131 to the wireless communication terminal 101. When receiving the control information for turning on the amplifier 131, the wireless communication terminal 101 turns on the amplifier 131.

Next, as illustrated in c of the drawing, it is assumed that the wireless communication terminal 101 moves while turning on the amplifier 131 and enters a position with low reception strength. At this time, the wireless communication terminal 101 can perform positioning while turning on the amplifier 131, and can succeed in positioning even in a case where the wireless communication terminal 101 is at a position with low reception strength.

Next, as illustrated in “d” in the drawing, the wireless communication terminal 101 performs positioning after movement, and transmits position information of the wireless communication terminal 101 to the base station 102. At this time, it is assumed that the peripheral area PEA of the wireless communication terminal 101 is at a position with high reception strength. When receiving the position information of the wireless communication terminal 101, the base station 102 predicts the reception strength of the peripheral area PEA of the wireless communication terminal 101. At this time, when the base station 102 predicts that the reception strength of the peripheral area PEA of the wireless communication terminal 101 is high, the base station 102 transmits control information for turning off the amplifier 131 to the wireless communication terminal 101. When receiving the control information for turning off the amplifier 131, the wireless communication terminal 101 switches the amplifier 131 from on to off. In a case where the reception strength of the peripheral area PEA of the wireless communication terminal 101 is high, the wireless communication terminal 101 can perform positioning by switching the amplifier 131 from on to off, and power consumption can be reduced.

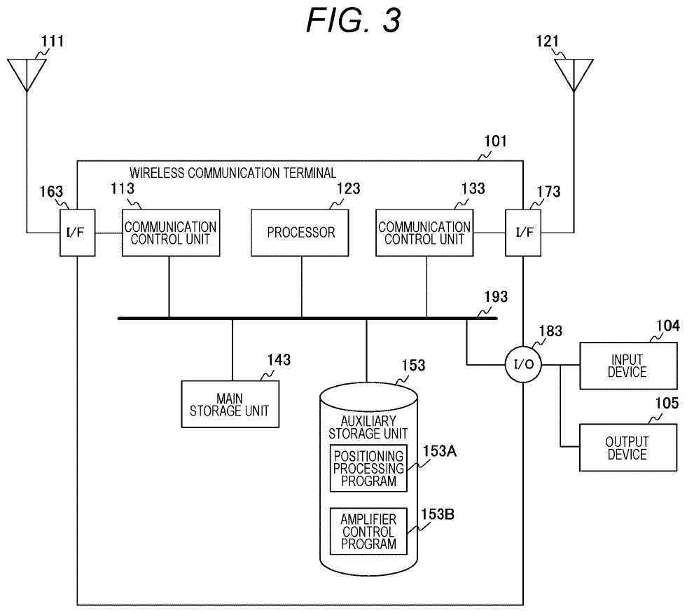

FIG. 3 is a block diagram illustrating a hardware configuration example of the wireless communication terminal according to the first embodiment.

In the drawing, the wireless communication terminal 101 includes a processor 123, communication control units 113 and 133, communication interfaces 163 and 173, a main storage unit 143, an auxiliary storage unit 153, and an input/output interface 183. The processor 123, the communication control units 113 and 133, the communication interfaces 163 and 173, the main storage unit 143, the auxiliary storage unit 153, and the input/output interface 183 are mutually connected via an internal bus 193. The main storage unit 143 and the auxiliary storage unit 153 are accessible from the processor 123.

In addition, the wireless communication terminal 101 is provided with an input device 104 and an output device 105. The input device 104 and the output device 105 are connected to the internal bus 193 via the input/output interface 183. The input device 104 is, for example, a keyboard, a mouse, a touch panel, a card reader, a voice input device, or the like. The output device 105 is, for example, a screen display device (liquid crystal monitor, organic electro luminescence (EL) display, graphic card, and the like), an audio output device (a speaker or the like), a printer, or the like.

The processor 123 is hardware that controls the operation of the entire wireless communication terminal 101. The processor 123 may be a central processing unit (CPU) or a graphics processing unit (GPU). The processor 123 may be a single-core processor or a multi-core processor. The processor 123 may include a hardware circuit (for example, a field-programmable gate array (FPGA) or an application specific integrated circuit (ASIC)) such as an accelerator that performs a part of the processing.

The main storage unit 143 can include, for example, a semiconductor memory such as a static random access memory (SRAM) or a dynamic random access memory (DRAM). The main storage unit 143 can store a program being executed by the processor 123 or can be provided with a work area for the processor 123 to execute the program.

The auxiliary storage unit 153 is a storage device having a large storage capacity, and is, for example, a hard disk device or a solid state drive (SSD). The auxiliary storage unit 153 can hold execution files of various programs and data used for executing the programs. The auxiliary storage unit 153 can store a positioning processing program 153A and an amplifier control program 153B. The positioning processing program 153A and the amplifier control program 153B may be software that can be installed in the wireless communication terminal 101 or may be incorporated as firmware in the wireless communication terminal 101.

The communication control unit 113 is hardware having a function of controlling communication between the wireless communication terminal 101 and the GNSS satellite 103. The communication control unit 133 is hardware having a function of controlling communication between the wireless communication terminal 101 and the base station 102.

The communication interface 163 is hardware used for establishing communication between the wireless communication terminal 101 and the GNSS satellite 103. The communication interface 163 is connected to the antenna 111. The communication interface 163 can include the amplifier 131 of FIG. 1. The communication interface 173 is hardware used for establishing communication between the wireless communication terminal 101 and the base station 102. The communication interface 173 is connected to the antenna 121. The communication interface 173 can support wireless communication using at least one of LPWA, WiFi, BlueTooth, BLE, or cellular communication.

The input/output interface 183 converts data input from the input device 104 into a data format that can be processed by the processor 123, and converts data output from the processor 123 into a data format that can be processed by the output device 105.

The processor 123 can perform positioning of the wireless communication terminal 101 by reading the positioning processing program 153A into the main storage unit 143 and executing the positioning processing program 153A. The processor 123 can cause the base station 102 to transmit the position information of the wireless communication terminal 101 by reading the amplifier control program 153B into the main storage unit 143 and executing the amplifier control program 153B. Then, the processor 123 can perform on/off control of the amplifier 131 provided in the communication interface 163 on the basis of the amplifier operation instruction signal transmitted from the base station 102.

Note that execution of the positioning processing program 153A and the amplifier control program 153B may be shared by a plurality of processors or computers. Alternatively, the processor 123 may instruct a cloud computer or the like to execute all or a part of the positioning processing program 153A and the amplifier control program 153B via a network, and may receive the execution result.

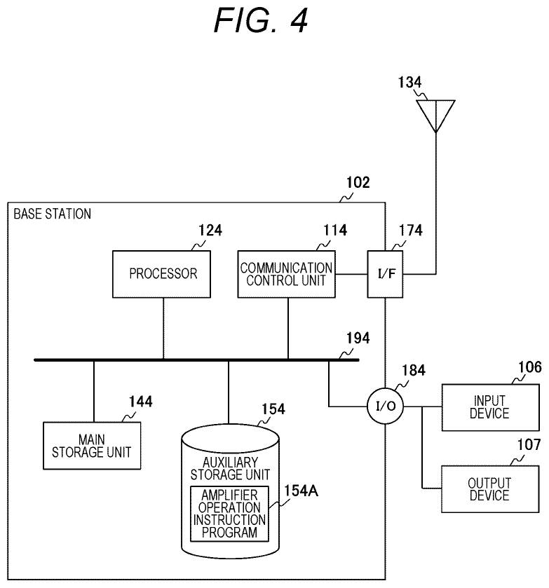

FIG. 4 is a block diagram illustrating a hardware configuration example of the base station according to the first embodiment.

In the drawing, the base station 102 includes a processor 124, a communication control unit 114, a communication interface 174, a main storage unit 144, an auxiliary storage unit 154, and an input/output interface 184. The processor 124, the communication control unit 114, the communication interface 174, the main storage unit 144, the auxiliary storage unit 154, and the input/output interface 184 are mutually connected via an internal bus 194. The main storage unit 144 and the auxiliary storage unit 154 are accessible from the processor 124.

In addition, the base station 102 is provided with an input device 106 and an output device 107. The input device 106 and the output device 107 are connected to the internal bus 194 via the input/output interface 184. The input device 106 is, for example, a keyboard, a mouse, a touch panel, a card reader, a voice input device, or the like. The output device 107 is, for example, a screen display device (liquid crystal monitor, organic electro luminescence (EL) display, graphic card, and the like), an audio output device (speaker or the like), a printer, or the like.

The processor 124 is hardware that controls the operation of the entire base station 102. The processor 124 may be a CPU or a GPU. The processor 124 may be a single-core processor or a multi-core processor. The processor 124 may include a hardware circuit such as an accelerator that performs a part of the processing.

The main storage unit 144 can include, for example, a semiconductor memory such as SRAM or DRAM. The main storage unit 144 can store a program being executed by the processor 124 or can be provided with a work area for the processor 124 to execute the program.

The auxiliary storage unit 154 is a storage device having a large storage capacity, and is, for example, a hard disk device or an SSD. The auxiliary storage unit 154 can hold execution files of various programs and data used for executing the programs. The auxiliary storage unit 154 can store an amplifier operation instruction program 154A. The amplifier operation instruction program 154A may be software that can be installed in the base station 102 or may be incorporated as firmware in the base station 102.

The communication control unit 114 is hardware having a function of controlling communication between the base station 102 and the wireless communication terminal 101. The communication interface 174 is hardware used for establishing communication between the base station 102 and the wireless communication terminal 101. The communication interface 174 is connected to the antenna 134. The communication interface 174 can support wireless communication using at least one of LPWA, WiFi, BlueTooth, BLE, or cellular communication.

The input/output interface 184 converts data input from the input device 106 into a data format that can be processed by the processor 124, and converts data output from the processor 124 into a data format that can be processed by the output device 107.

The processor 124 can read the amplifier operation instruction program 154A into the main storage unit 144 and execute the amplifier operation instruction program 154A to instruct on/off of the amplifier 131 provided in the wireless communication terminal 101.

Note that the execution of the amplifier operation instruction program 154A may be shared by a plurality of processors or computers. Alternatively, the processor 124 may instruct a cloud computer or the like to execute all or a part of the amplifier operation instruction program 154A via a network, and may receive the execution result.

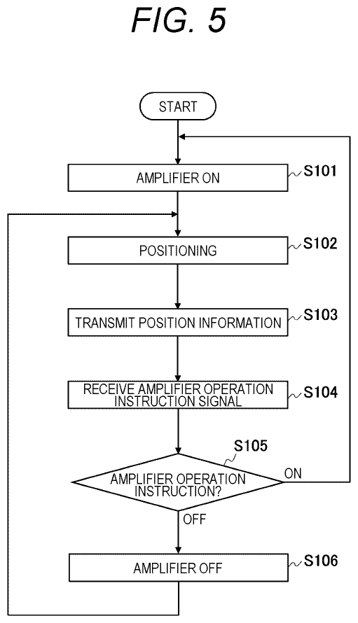

FIG. 5 is a flowchart illustrating an operation example of the wireless communication terminal according to the first embodiment.

In the drawing, the wireless communication terminal 101 turns on the amplifier 131 (step S101) and then performs positioning (step S102).

Next, the wireless communication terminal 101 transmits the position information of the wireless communication terminal 101 obtained by the positioning to the base station 102 (step S103).

Next, the wireless communication terminal 101 receives an amplifier operation instruction signal instructing to turn on/off the amplifier 131 from the base station 102 (step S104).

Next, in a case where the base station 102 instructs the wireless communication terminal 101 to turn off the amplifier 131, the wireless communication terminal 101 turns off the amplifier 131 and returns to step S102. On the other hand, in a case where the base station 102 instructs the wireless communication terminal 101 to turn on the amplifier 131, the wireless communication terminal 101 returns to step S101, turns on the amplifier 131, and performs positioning (step S102).

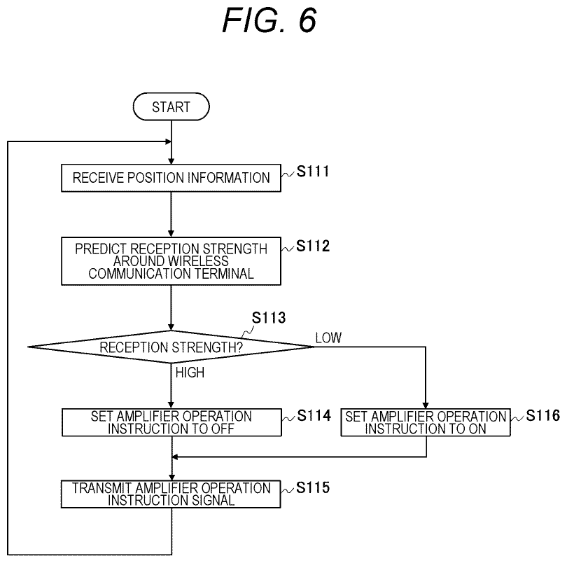

FIG. 6 is a flowchart illustrating an operation example of the base station according to the first embodiment.

In the drawing, the base station 102 receives the position information of the wireless communication terminal 101 from the wireless communication terminal 101 (step S111).

Next, the base station 102 predicts reception strength around the wireless communication terminal 101 on the basis of the position information of the wireless communication terminal 101 (step S112).

Next, the base station 102 determines the level of the reception strength around the wireless communication terminal 101 (step S113). Then, in a case of determining that the reception strength around the wireless communication terminal 101 is high, the base station 102 sets the amplifier operation instruction to off (step S114), and transmits the amplifier operation instruction signal to the wireless communication terminal 101 (step S115). On the other hand, in a case of determining that the reception strength around the wireless communication terminal 101 is low, the base station 102 sets the amplifier operation instruction to on (step S116), and transmits the amplifier operation instruction signal to the wireless communication terminal 101 (step S115).

As described above, in the first embodiment described above, the base station 102 predicts the reception strength around the wireless communication terminal 101 on the basis of the position information of the wireless communication terminal 101, and performs on/off control of the amplifier 131 of the wireless communication terminal 101 on the basis of the prediction result. As a result, the wireless communication terminal 101 does not need to always turn on the amplifier 131 at the time of positioning processing for turning off the amplifier 131, and power consumption can be reduced. Furthermore, the base station 102 can turn on the amplifier before the amplifier 131 is turned off and cannot perform positioning, and can suppress an increase in power consumption for coping with the inability to perform positioning. For example, in a case where the wireless communication terminal 101 is an ELTRES terminal, the life of the battery can be extended by about 1.3 times.

### 2. Second Embodiment

In the first embodiment described above, the wireless communication terminal 101 performs positioning on the basis of communication using the GNSS satellite 103, and controls the operation of the amplifier 131 of the wireless communication terminal 101 according to an instruction from the base station 102 based on the reception strength of the peripheral area of the wireless communication terminal 101. In the second embodiment, the wireless communication terminal performs positioning on the basis of communication with the first base station, and controls the operation of the amplifier of the wireless communication terminal according to an instruction from the second base station based on the reception strength of the peripheral area of the wireless communication terminal.

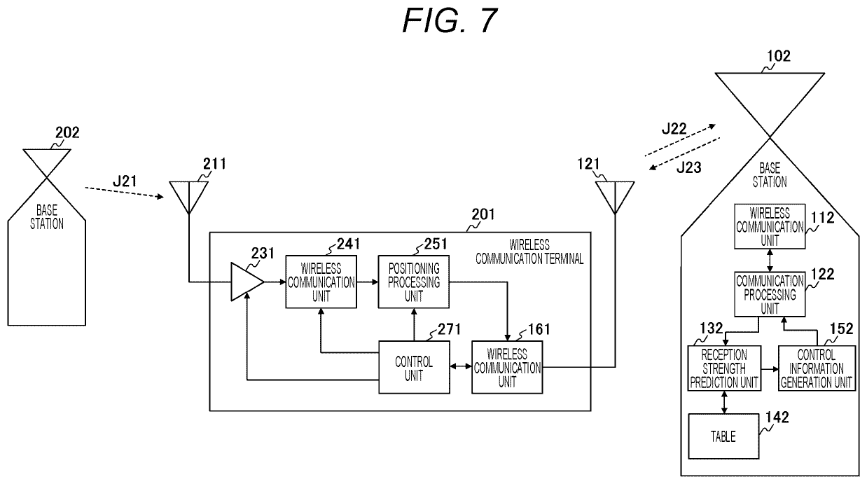

FIG. 7 is a block diagram illustrating a functional configuration example of a wireless communication system according to a second embodiment.

In the drawing, the wireless communication system includes a wireless communication terminal 201 and a base station 202 instead of the wireless communication terminal 101 and the GNSS satellite 103 of the first embodiment described above. Other configurations of the wireless communication system of the second embodiment are similar to those of the wireless communication system of the first embodiment described above.

The wireless communication terminal 201 includes an antenna 211, an amplifier 231, a wireless communication unit 241, a positioning processing unit 251, and a control unit 271 instead of the antenna 111, the amplifier 131, the wireless communication unit 141, the positioning processing unit 151, and the control unit 171 of the first embodiment described above. Other configurations of the wireless communication terminal 201 of the second embodiment are similar to the configuration of the wireless communication terminal 101 of the first embodiment described above.

The antenna 211 receives a signal transmitted from the base station 202. The amplifier 231 amplifies the signal received via the antenna 211. The amplifier 231 may be an LNA.

The wireless communication unit 241 performs wireless communication with the base station 202. Then, the wireless communication unit 241 extracts a signal used for positioning from the signal amplified by the amplifier 231 and outputs the signal to the positioning processing unit 251. At this time, the wireless communication unit 241 can support wireless communication using at least one of LPWA, WiFi, BlueTooth, BLE, or cellular communication.

The positioning processing unit 251 performs positioning processing on the basis of a signal received via the wireless communication unit 241. In this positioning processing, the current position of the wireless communication terminal 201 is calculated. The positioning processing unit 251 can obtain the position information of the wireless communication terminal 201 from the communicable base station 202. At this time, the positioning processing unit 251 can perform positioning calculation on the basis of a signal using at least one of LPWA, WiFi, BlueTooth, BLE, cellular communication, received signal strength, or an arrival angle. For example, in the cellular communication, the positioning processing unit 251 may determine that the position information of the wireless communication terminal 201 is within the cell range of the base station that has received the position information. Alternatively, in BlueTooth, the positioning processing unit 251 may determine that the position information of the wireless communication terminal 201 is the position of the base station that has received the position information. Alternatively, if WiFi can communicate with a plurality of base stations, the positioning processing unit 251 may calculate the position information of the wireless communication terminal 201 on the basis of triangulation. Alternatively, in LPWA, the positioning processing unit 251 may perform distance measurement from the response time of communication and calculate the position information of the wireless communication terminal 201. Alternatively, in a case where the arrival angle can be detected, the positioning processing unit 251 may calculate the position information on the basis of Angle of Arrival (AoA) or Angle of Departure (AoD). Note that, in a case where a positioning sensor such as an acceleration sensor, a gyro sensor, or a magnetic sensor is mounted on the wireless communication terminal 201, the positioning processing unit 251 may perform positioning by combining these pieces of data.

The control unit 271 controls operations of the amplifier 231, the wireless communication unit 241, and the positioning processing unit 251. At this time, the control unit 271 can control the operation of the amplifier 231 on the basis of the control information regarding the positioning processing of the wireless communication terminal 201 transmitted from the base station 102. For example, in a case where the base station 102 instructs the control unit 271 to turn on the amplifier 231, the control unit 271 can turn on the amplifier 231 at the time of positioning. Furthermore, in a case where the base station 102 instructs the control unit 271 to turn off the amplifier 231, the control unit 271 can turn off the amplifier 231 at the time of positioning.

The base station 202 performs communication with the wireless communication terminal 201. The base station 202 can transmit a signal used for positioning the wireless communication terminal 201 to the wireless communication terminal 201. The base station 202 can support wireless communication using at least one of LPWA, WiFi, BlueTooth, BLE, or cellular communication.

When receiving the signal transmitted from the base station 202 (J21), the wireless communication terminal 201 performs positioning on the basis of the signal, and transmits position information of the wireless communication terminal 201 to the base station 102 (J22). The base station 102 predicts reception strength around the wireless communication terminal 201 on the basis of the position information of the wireless communication terminal 201. Then, the base station 102 generates control information instructing on/off of the amplifier 231 on the basis of the prediction result, and transmits the control information to the wireless communication terminal 201 (J23). The wireless communication terminal 201 turns on/off the amplifier 231 on the basis of the control information that is transmitted from the base station 102 and instructs on/off of the amplifier 231.

As described above, in the second embodiment described above, the wireless communication terminal 201 calculates the position information of the wireless communication terminal 201 on the basis of the communication with the base station 202, and transmits the position information to the base station 102. As a result, the wireless communication terminal 201 does not need to perform communication with the GNSS satellite 103 in order to calculate the position information of the wireless communication terminal 201, and power consumption can be reduced.

### 3. Third Embodiment

In the second embodiment described above, the wireless communication terminal 201 performs positioning on the basis of communication with the base station 202, and controls the operation of the amplifier 231 of the wireless communication terminal 201 according to the instruction from the base station 102 based on the reception strength of the peripheral area of the wireless communication terminal 201. In the third embodiment, a wireless communication terminal performs positioning on the basis of communication with a base station, and controls an operation of an amplifier of the wireless communication terminal according to an instruction from the base station based on reception strength of a peripheral area of the wireless communication terminal.

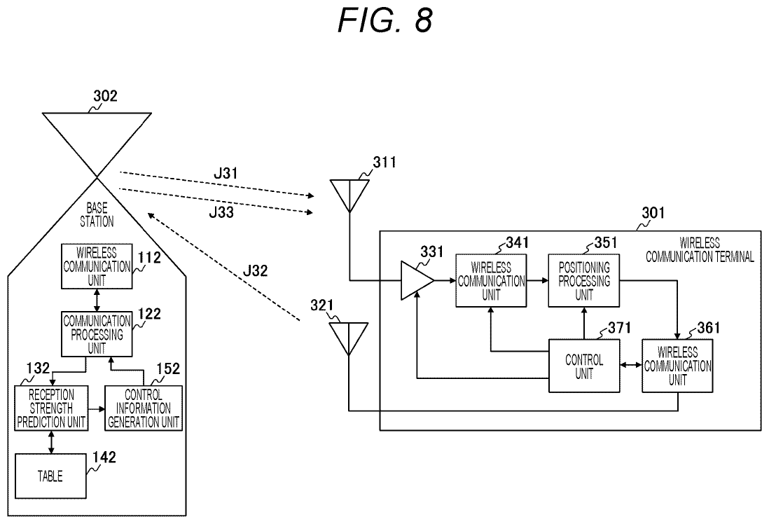

FIG. 8 is a block diagram illustrating a functional configuration example of a wireless communication system according to a third embodiment.

In the drawing, the wireless communication system includes a wireless communication terminal 301 and a base station 302.

The wireless communication terminal 301 includes a reception antenna 311, a transmission antenna 321, an amplifier 331, wireless communication units 341 and 361, a positioning processing unit 351, and a control unit 371.

The reception antenna 311 receives a signal transmitted from the base station 302. The amplifier 331 amplifies the signal received via the reception antenna 311. The amplifier 331 may be an LNA. The transmission antenna 321 transmits a signal to the base station 302.

Each of the wireless communication units 341 and 361 performs wireless communication with the base station 302. At this time, the wireless communication unit 341 extracts a signal used for positioning from the signal amplified by the amplifier 331 and outputs the signal to the positioning processing unit 351. In addition, the wireless communication unit 341 can receive, from the base station 302, control information for controlling power consumption related to positioning processing of the wireless communication terminal 301. The control information can include a signal for turning on or off the amplifier 331. The wireless communication unit 361 transmits the position information of the wireless communication terminal 301 to the base station 302 via the transmission antenna 321. At this time, each of the wireless communication units 341 and 361 can support wireless communication using at least one of LPWA, WiFi, BlueTooth, BLE, or cellular communication.

The positioning processing unit 351 performs positioning processing on the basis of a signal received via the wireless communication unit 341. In this positioning processing, the current position of the wireless communication terminal 301 is calculated. The positioning processing unit 351 can obtain the position information of the wireless communication terminal 301 from the communicable base station 302. At this time, the positioning processing unit 351 can perform positioning calculation on the basis of a signal using at least one of GNSS, LPWA, WiFi, BlueTooth, BLE, cellular communication, received signal strength, or an arrival angle.

The control unit 371 controls operations of the amplifier 331, the wireless communication units 341 and 361, and the positioning processing unit 351. At this time, the control unit 371 can control the operation of the amplifier 331 on the basis of the control information regarding the positioning processing of the wireless communication terminal 301 transmitted from the base station 302. For example, in a case where the base station 302 instructs the control unit 371 to turn on the amplifier 331, the control unit 371 can turn on the amplifier 331 at the time of positioning. Furthermore, in a case where the base station 302 instructs the control unit 371 to turn off the amplifier 331, the control unit 371 can turn off the amplifier 331 at the time of positioning.

The base station 302 performs communication with the wireless communication terminal 301. The base station 302 can transmit a signal used for positioning the wireless communication terminal 301 to the wireless communication terminal 301. Furthermore, the base station 302 can have a configuration similar to that of the base station 102 of the first embodiment described above. At this time, the base station 302 can support wireless communication using at least one of LPWA, WiFi, BlueTooth, BLE, or cellular communication.

When receiving the signal transmitted from the base station 302 (J31), the wireless communication terminal 301 performs positioning on the basis of the signal, and transmits position information of the wireless communication terminal 301 to the base station 302 (J32). The base station 302 predicts reception strength around the wireless communication terminal 301 on the basis of the position information of the wireless communication terminal 301. Then, the base station 302 generates control information instructing on/off of the amplifier 331 on the basis of the prediction result, and transmits the control information to the wireless communication terminal 301 (J33). The wireless communication terminal 301 turns on/off the amplifier 331 on the basis of the control information that is transmitted from the base station 302 and instructs on/off of the amplifier 331.

As described above, in the third embodiment described above, the wireless communication terminal 301 performs positioning on the basis of communication with the base station 302, and transmits the position information of the wireless communication terminal 301 to the base station 302. Then, the wireless communication terminal 301 controls the operation of the amplifier 331 on the basis of an instruction from the base station 302 based on the reception strength of the peripheral area of the wireless communication terminal 301. As a result, the wireless communication terminal 301 can perform on/off control of the amplifier 331 on the basis of a single communication method, and it is possible to reduce power consumption while simplifying the configuration of the wireless communication terminal 301.

### 4. Fourth Embodiment

In the first embodiment described above, the wireless communication terminal 101 performs positioning on the basis of communication using the GNSS satellite 103, and controls the operation of the amplifier 131 of the wireless communication terminal 101 according to an instruction from the base station 102 based on the reception strength of the peripheral area of the wireless communication terminal 101. In the fourth embodiment, the wireless communication terminal performs positioning on the basis of communication using the GNSS satellite 103, and controls positioning of the wireless communication terminal according to an instruction from the base station based on the position accuracy setting of the wireless communication terminal.

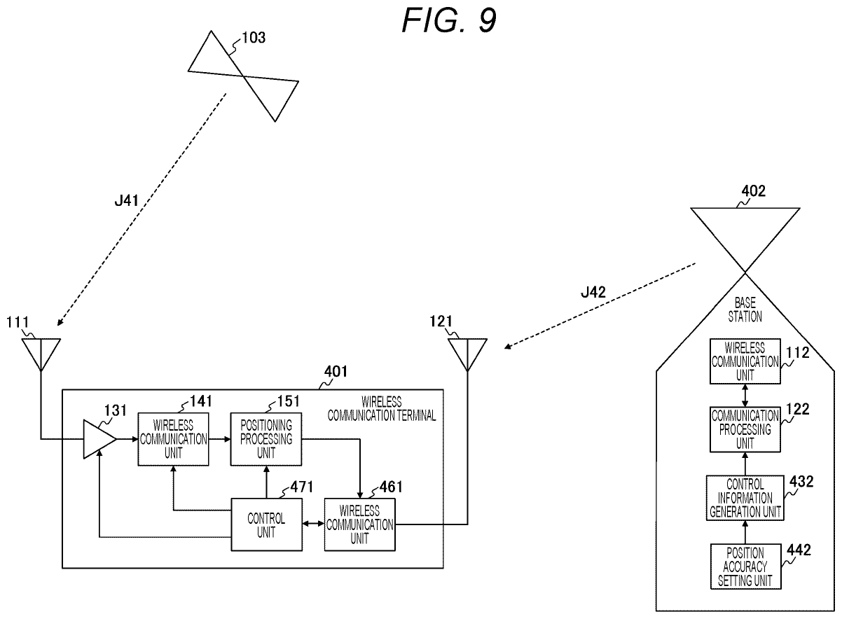

FIG. 9 is a block diagram illustrating a functional configuration example of a wireless communication system according to the fourth embodiment.

In the drawing, the wireless communication system includes a wireless communication terminal 401 and a base station 402 instead of the wireless communication terminal 101 and the base station 102 of the first embodiment described above. Other configurations of the wireless communication system of the fourth embodiment are similar to those of the wireless communication system of the first embodiment described above.

The wireless communication terminal 401 performs wireless communication with the GNSS satellite 103, and performs positioning processing on the basis of reception data via the wireless communication. In addition, the wireless communication terminal 401 can perform wireless communication with the base station 402, receive control information for controlling power consumption related to positioning processing, and control power consumption related to positioning processing on the basis of the control information. The wireless communication terminal 401 may be a mobile terminal such as a smartphone, may be fixed to a mobile body used in IoT or the like and used, or may be used as a positioning device. The wireless communication terminal 401 may be an ELTRES terminal corresponding to ELTRES.

The wireless communication terminal 401 includes a wireless communication unit 461 and a control unit 471 instead of the wireless communication unit 161 and the control unit 171 of the wireless communication terminal 101 of the first embodiment described above. Other configurations of the wireless communication terminal 401 of the fourth embodiment are similar to the configuration of the wireless communication terminal 101 of the first embodiment described above.

The wireless communication unit 461 performs wireless communication with the base station 402. At this time, the wireless communication unit 461 can receive, from the base station 402, control information for controlling power consumption related to positioning processing of the wireless communication terminal 401. This control information can include a signal for turning on or off the operation of the positioning processing unit 151. The control information may include a signal for turning on or off the operations of the amplifier 131 and the wireless communication unit 141. At this time, the wireless communication unit 461 can support wireless communication using at least one of LPWA, WiFi, BlueTooth, BLE, or cellular communication.

The control unit 471 controls operations of the amplifier 131, the wireless communication unit 141, and the positioning processing unit 151. At this time, the control unit 471 can control the operation of the positioning processing unit 151 on the basis of the control information regarding the positioning processing of the wireless communication terminal 401 transmitted from the base station 402. For example, in a case where the base station 402 instructs the control unit 471 to turn on the operation of the positioning processing unit 151, the control unit 471 can turn on the operation of the positioning processing unit 151 at the time of positioning. Further, in a case where the base station 402 instructs the control unit 471 to turn off the operation of the positioning processing unit 151, the control unit 471 can turn off the operation of the positioning processing unit 151 at the time of positioning. The control unit 471 may control the operations of the amplifier 131 and the wireless communication unit 141 on the basis of control information regarding positioning processing of the wireless communication terminal 401 transmitted from the base station 402.

The base station 402 performs wireless communication with the wireless communication terminal 401. Furthermore, the base station 402 can generate control information for controlling power consumption related to positioning processing of the wireless communication terminal 401 and transmit the control information to the wireless communication terminal 401. The base station 402 may perform wireless communication using at least one of LPWA, WiFi, BlueTooth, BLE, or cellular communication.

The base station 402 includes a control information generation unit 432 and a position accuracy setting unit 442 instead of the reception strength prediction unit 132, the table 142, and the control information generation unit 152 of the base station 102 of the first embodiment described above. Other configurations of the base station 402 of the fourth embodiment are similar to those of the base station 102 of the first embodiment described above.

The position accuracy setting unit 442 sets position accuracy of the wireless communication terminal 401. The position accuracy of the wireless communication terminal 401 may be, for example, high accuracy or low accuracy. In the low accuracy, for example, the position accuracy of the wireless communication terminal 401 may be set to a range of several kilometers or a range of several hundred meters. In the high accuracy, for example, the position accuracy of the wireless communication terminal 401 may be set to a range of several meters or a range of several tens of meters. The position accuracy setting unit 442 may set the position accuracy of the wireless communication terminal 401 on the basis of at least one of external designation, scheduling, position information, an application, or a contract form. The external designation may be user designation or computer designation. In the scheduling, for example, high accuracy may be set in the daytime and low accuracy may be set in the nighttime. Alternatively, in the scheduling, for example, the operating time of the mobile body on which the wireless communication terminal 401 is mounted may be set with high accuracy, and the non-operating time of the mobile body on which the wireless communication terminal 401 is mounted may be set with low accuracy. In the position information, for example, in tracking of a truck during transportation, the position accuracy setting of the wireless communication terminal 401 may be switched depending on whether the vehicle has entered the same cell as the office. In the application, for example, the position accuracy setting of the wireless communication terminal 401 may be switched depending on the tracking target. For example, the accuracy may be set with high accuracy in tracking a route guide, a child's behavior, or sports, and the accuracy may be set to low accuracy in tracking a truck during transportation. In the contract form, for example, the position accuracy setting of the wireless communication terminal 401 may be switched according to the date and time or the day of the week.

The control information generation unit 432 generates control information for controlling the power consumption related to the positioning processing on the basis of the position accuracy setting of the wireless communication terminal 401. This control information can include a signal for turning on or off the operation of the positioning processing unit 151 of the wireless communication terminal 401.

The wireless communication terminal 401 receives the data transmitted from the GNSS satellite 103 (J41). The base station 402 generates control information instructing on/off of the operation of the positioning processing unit 151 on the basis of the position accuracy setting of the wireless communication terminal 401, and transmits the control information to the wireless communication terminal 401 (J42). The wireless communication terminal 401 turns on/off the operation of the positioning processing unit 151 on the basis of control information that is transmitted from the base station 402 and instructs on/off of the operation of the positioning processing unit 151.

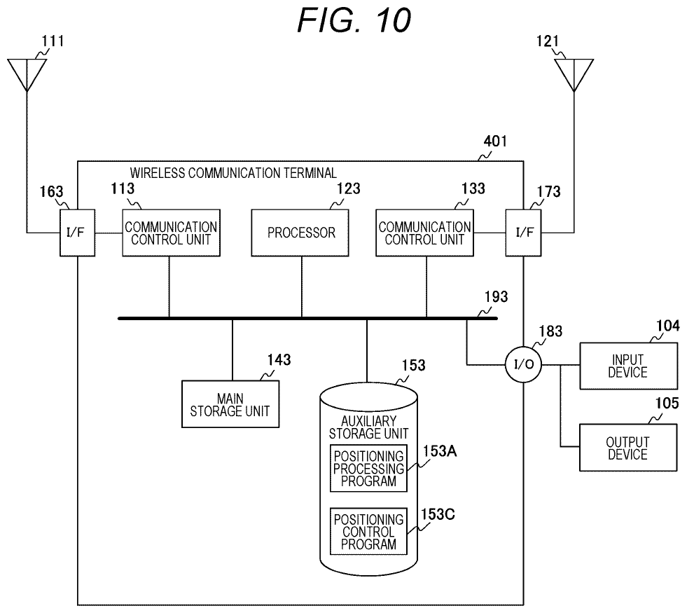

FIG. 10 is a block diagram illustrating a hardware configuration example of the wireless communication terminal according to the fourth embodiment.

In the drawing, the wireless communication terminal 401 can be configured similarly to the wireless communication terminal 101 of the first embodiment described above. However, in the wireless communication terminal 401, instead of the amplifier control program 153B, a positioning control program 153C is stored in the auxiliary storage unit 153.

The processor 123 can perform positioning of the wireless communication terminal 401 by reading the positioning processing program 153A into the main storage unit 143 and executing the positioning processing program 153A. The processor 123 can read the positioning control program 153C into the main storage unit 143 and execute the positioning control program 153C to perform on/off control of the operation of the positioning processing on the basis of the position accuracy setting transmitted from the base station 402.

Note that execution of the positioning processing program 153A and the positioning control program 153C may be shared by a plurality of processors and computers. Alternatively, the processor 123 may instruct a cloud computer or the like to execute all or a part of the positioning processing program 153A and the positioning control program 153C via a network, and may receive the execution result.

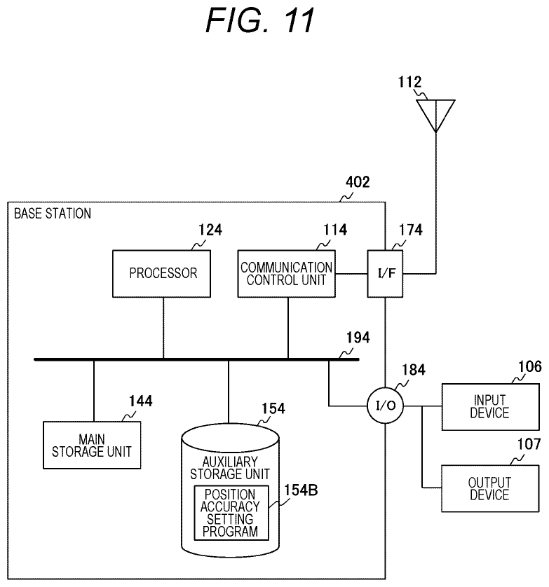

FIG. 11 is a block diagram illustrating a hardware configuration example of the base station according to the fourth embodiment.

In the drawing, the base station 402 can be configured similarly to the base station 102 of the first embodiment described above. However, in the base station 402, a position accuracy setting program 154B is stored in the auxiliary storage unit 154 instead of the amplifier operation instruction program 154A.

The processor 124 can set the position accuracy of the wireless communication terminal 401 and transmit the position accuracy to the wireless communication terminal 401 by reading the position accuracy setting program 154B into the main storage unit 144 and executing the position accuracy setting program 154B.

Note that execution of the position accuracy setting program 154B may be shared by a plurality of processors or computers. Alternatively, the processor 124 may instruct a cloud computer or the like to execute all or a part of the position accuracy setting program 154B via a network, and may receive the execution result.

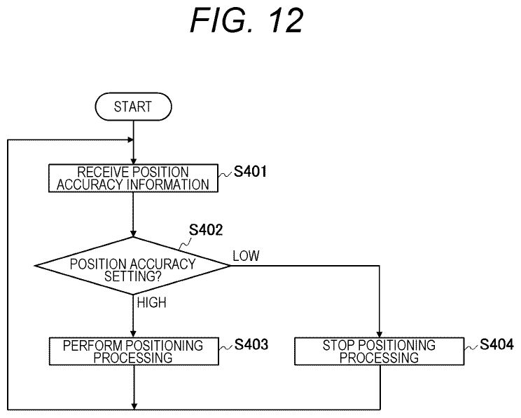

FIG. 12 is a flowchart illustrating an operation example of the wireless communication terminal according to the fourth embodiment.

In the drawing, the wireless communication terminal 401 receives the position accuracy setting information of the wireless communication terminal 401 from the base station 402 (step S401).

Next, the wireless communication terminal 401 determines the level of the position accuracy setting of the wireless communication terminal 401 (step S402). Then, in a case where the position accuracy setting is high, the wireless communication terminal 401 performs positioning processing (step S403), and returns to step S401. On the other hand, in a case where the position accuracy setting is low, the wireless communication terminal 401 stops the positioning processing (step S404), and returns to step S401.

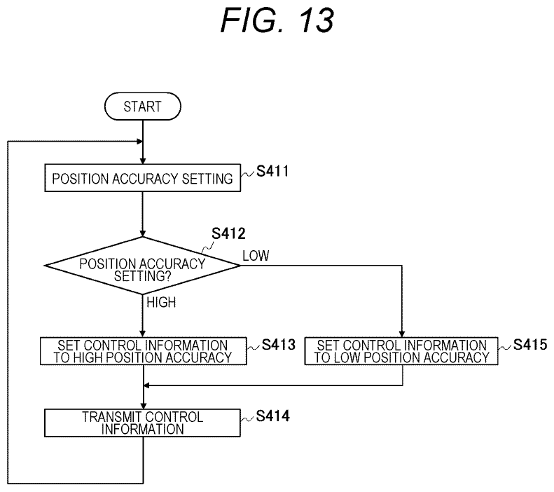

FIG. 13 is a flowchart illustrating an operation example of the base station according to the fourth embodiment.

In the drawing, the base station 402 sets the position accuracy of the wireless communication terminal 401 (step S411).

Next, the base station 402 determines the level of the position accuracy setting of the wireless communication terminal 401 (step S412). Then, in a case where the position accuracy setting of the wireless communication terminal 401 is high, the base station 402 sets the control information to high position accuracy (step S413), and transmits the control information to the wireless communication terminal 401 (step S414). On the other hand, in a case where the position accuracy of the wireless communication terminal 401 is low, the base station 402 sets the control information to low position accuracy (step S415), and transmits the control information to the wireless communication terminal 401 (step S414).

As described above, in the above-described fourth embodiment, the wireless communication terminal 401 switches between execution and stop of the positioning processing on the basis of the position accuracy information of the wireless communication terminal 401 transmitted from the base station 402. As a result, the wireless communication terminal 401 can perform positioning according to the necessity of positioning of the wireless communication terminal 401, and can stop unnecessary positioning processing and reduce power consumption. For example, in a case where the wireless communication terminal 101 is an ELTRES terminal, the life of the battery can be extended by about 3 times.

### 5. Fifth Embodiment

In the fourth embodiment described above, the wireless communication terminal 401 performs communication with the GNSS satellite 103, and controls the operation of the positioning processing unit 151 of the wireless communication terminal 401 according to the instruction from the base station 402 based on the position accuracy of the wireless communication terminal 401. In the fifth embodiment, the wireless communication terminal performs communication for positioning with the first base station, and controls the operation of the positioning processing unit of the wireless communication terminal according to an instruction from the second base station based on the position accuracy of the wireless communication terminal.

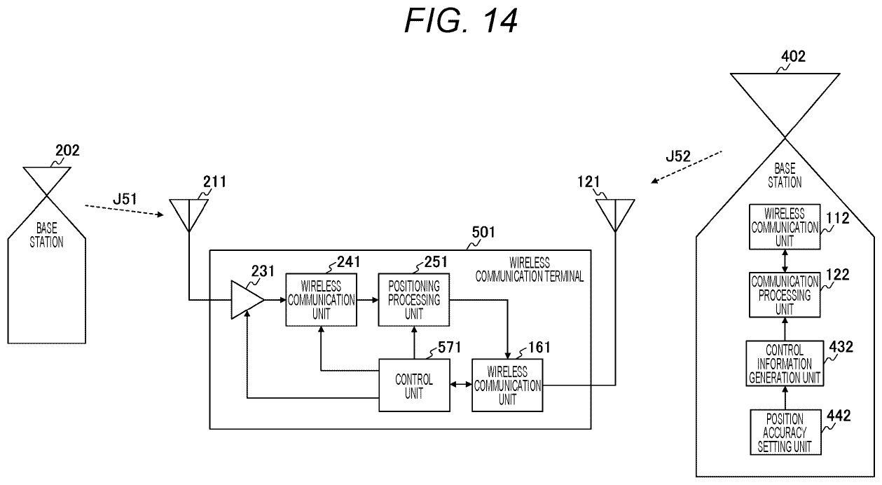

FIG. 14 is a block diagram illustrating a functional configuration example of a wireless communication system according to the fifth embodiment.

In the drawing, the wireless communication system includes a wireless communication terminal 501 and a base station 202 instead of the wireless communication terminal 401 and the GNSS satellite 103 of the fourth embodiment described above. Other configurations of the wireless communication system of the fifth embodiment are similar to those of the wireless communication system of the fourth embodiment described above.

The wireless communication terminal 501 includes a control unit 571 instead of the control unit 271 of the second embodiment described above. Other configurations of the wireless communication terminal 501 of the fifth embodiment are similar to the configuration of the wireless communication terminal 201 of the second embodiment described above.

The control unit 571 controls operations of the amplifier 231, the wireless communication unit 241, and the positioning processing unit 251. At this time, the control unit 571 can control the operation of the positioning processing unit 251 on the basis of the position accuracy information of the wireless communication terminal 501 transmitted from the base station 402. For example, in a case where the position accuracy setting of the wireless communication terminal 501 is high, the control unit 571 can turn on the operation of the positioning processing unit 251. Furthermore, in a case where the position accuracy setting of the wireless communication terminal 501 is low, the control unit 571 can turn off the operation of the positioning processing unit 251.

The wireless communication terminal 501 receives a signal used for positioning transmitted from the base station 202 (J51). At this time, when receiving the position accuracy information of the wireless communication terminal 501 from the base station 402 (J52), the wireless communication terminal 501 checks the level of the position accuracy setting of the wireless communication terminal 501. Then, the wireless communication terminal 501 turns on/off the operation of the positioning processing unit 251 on the basis of the level of the position accuracy setting of the wireless communication terminal 501.

As described above, in the above-described fifth embodiment, the wireless communication terminal 501 calculates the position information of the wireless communication terminal 501 on the basis of communication with the base station 202. As a result, the wireless communication terminal 501 does not need to perform communication with the GNSS satellite 103 in order to calculate the position information of the wireless communication terminal 501, and power consumption can be reduced.

### 6. Sixth Embodiment

In the fifth embodiment described above, the wireless communication terminal 501 performs communication for positioning with the base station 202, and controls the operation of the positioning processing unit 251 of the wireless communication terminal 501 according to an instruction from the base station 402 based on the position accuracy setting of the wireless communication terminal 501. In the sixth embodiment, a wireless communication terminal performs communication for positioning with a base station, and controls an operation of a positioning processing unit of the wireless communication terminal according to an instruction from the base station based on a position accuracy setting of the wireless communication terminal.

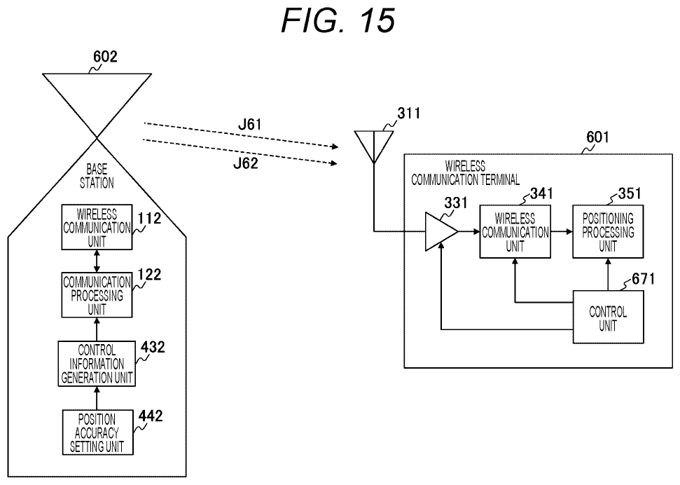

FIG. 15 is a block diagram illustrating a functional configuration example of a wireless communication system according to the sixth embodiment.

In the drawing, the wireless communication system includes a wireless communication terminal 601 and a base station 602.

The wireless communication terminal 601 includes a control unit 671 instead of the control unit 371 of the wireless communication terminal 301 of the third embodiment described above. In addition, in the wireless communication terminal 601, the transmission antenna 321 and the wireless communication unit 361 of the wireless communication terminal 301 of the third embodiment described above are removed. Other configurations of the wireless communication terminal 601 of the sixth embodiment are similar to the configuration of the wireless communication terminal 301 of the third embodiment described above.

The control unit 671 controls operations of the amplifier 331, the wireless communication unit 341, and the positioning processing unit 351. At this time, the control unit 671 can control the operation of the positioning processing unit 351 on the basis of the control information regarding the positioning processing of the wireless communication terminal 601 transmitted from the base station 602. For example, in a case where the position accuracy setting of the wireless communication terminal 601 is high, the control unit 671 can turn on the operation of the positioning processing unit 351. Furthermore, in a case where the position accuracy setting of the wireless communication terminal 601 is low, the control unit 671 can turn off the operation of the positioning processing unit 351.

The base station 602 performs communication with the wireless communication terminal 601. The base station 602 can transmit a signal used for positioning the wireless communication terminal 601 to the wireless communication terminal 601. Furthermore, the base station 602 can have a configuration similar to that of the base station 402 of the above-described fourth embodiment. At this time, the base station 602 can support wireless communication using at least one of LPWA, WiFi, BlueTooth, BLE, or cellular communication.

The wireless communication terminal 601 receives a signal used for positioning transmitted from the base station 602 (J61). At this time, when receiving the position accuracy information of the wireless communication terminal 601 from the base station 602 (J62), the wireless communication terminal 601 checks the level of the position accuracy setting of the wireless communication terminal 601. Then, the wireless communication terminal 601 turns on/off the operation of the positioning processing unit 351 on the basis of the level of the position accuracy setting of the wireless communication terminal 601.

As described above, in the above-described sixth embodiment, the wireless communication terminal 601 performs positioning on the basis of communication with the base station 602. At this time, the wireless communication terminal 601 controls the operation of the positioning processing unit 351 on the basis of an instruction from the base station 602 based on the position accuracy setting of the wireless communication terminal 601. As a result, the wireless communication terminal 601 can perform on/off control of the operation of the positioning processing unit 351 on the basis of a single communication method, and it is possible to reduce power consumption while simplifying the configuration of the wireless communication terminal 601.

### 7. Seventh Embodiment

In the sixth embodiment described above, the wireless communication terminal 601 performs communication for positioning with the base station 602, and controls the operation of the positioning processing unit 351 of the wireless communication terminal 601 according to an instruction from the base station 602 based on the position accuracy setting of the wireless communication terminal 601. In the seventh embodiment, a wireless communication terminal performs communication with the GNSS satellite 103, and controls the operation of the positioning processing unit of the wireless communication terminal on the basis of the position accuracy setting of the wireless communication terminal.

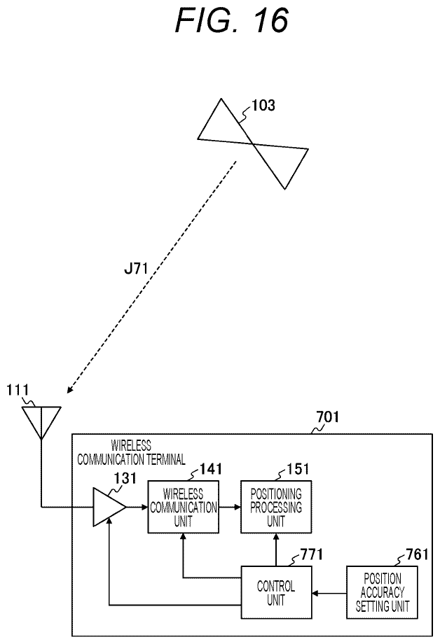

FIG. 16 is a block diagram illustrating a functional configuration example of a wireless communication system according to the seventh embodiment.

In the drawing, the wireless communication system includes a wireless communication terminal 701 instead of the wireless communication terminal 401 of the fourth embodiment described above. In addition, in the wireless communication system, the base station 402 of the fourth embodiment described above is omitted. Other configurations of the wireless communication system of the seventh embodiment are similar to those of the wireless communication system of the fourth embodiment described above.

The wireless communication terminal 701 includes a control unit 771 instead of the control unit 471 of the wireless communication terminal 401 of the fourth embodiment described above. In addition, in the wireless communication terminal 401, the antenna 121 and the wireless communication unit 461 of the wireless communication terminal 701 of the fourth embodiment described above are removed. In addition, in the wireless communication terminal 701, a position accuracy setting unit 761 is added to the wireless communication terminal 401 of the fourth embodiment described above. Other configurations of the wireless communication terminal 701 of the seventh embodiment are similar to the configuration of the wireless communication terminal 401 of the fourth embodiment described above.

The position accuracy setting unit 761 sets position accuracy of the wireless communication terminal 701. The position accuracy setting unit 761 may set the position accuracy of the wireless communication terminal 701 on the basis of at least one of external designation, scheduling, position information, an application, and a contract form.

The control unit 771 controls operations of the amplifier 131, the wireless communication unit 141, and the positioning processing unit 151. At this time, the control unit 771 can control the operation of the positioning processing unit 151 on the basis of the position accuracy information set by the position accuracy setting unit 761. For example, in a case where the position accuracy setting of the wireless communication terminal 701 is high, the control unit 771 can turn on the operation of the positioning processing unit 151. Furthermore, in a case where the position accuracy setting of the wireless communication terminal 701 is low, the control unit 771 can turn off the operation of the positioning processing unit 151.

The wireless communication terminal 701 receives the data transmitted from the GNSS satellite 103 (J71). At this time, the wireless communication terminal 701 checks the level of the position accuracy setting of the wireless communication terminal 701. Then, the wireless communication terminal 701 turns on/off the operation of the positioning processing unit 151 on the basis of the level of the position accuracy setting of the wireless communication terminal 701.

As described above, in the seventh embodiment described above, the wireless communication terminal 701 sets the position accuracy of the wireless communication terminal 701, and controls the operation of the positioning processing unit 151 on the basis of the position accuracy setting of the wireless communication terminal 701. As a result, the wireless communication terminal 701 can perform on/off control of the operation of the positioning processing unit 151 without performing communication with the base station 402, and it is possible to reduce power consumption while simplifying the configuration of the wireless communication terminal 701.

Note that the embodiments described above show examples for embodying the present technology, and the respective matters in the embodiments and the respective matters specifying the invention in the claims have correspondence relationships. Similarly, the respective matters specifying the invention in the claims and the respective matters with the same names in the embodiments of the present technology have correspondence relationships. However, the present technology is not limited to the embodiments, and can be embodied by making various modifications to the embodiments without departing from the scope of the present technology. Furthermore, effects described in the present specification are merely examples and are not limited, and other effects may be provided.

Note that the present technology may also have the following configuration.

(1) A wireless communication terminal including:
a wireless communication unit that performs wireless communication;
a positioning processing unit that performs positioning processing on the basis of reception data received via the wireless communication unit; and
a control unit that controls power consumption related to the positioning processing on the basis of control information regarding the positioning processing acquired via the wireless communication unit.

(2) The wireless communication terminal according to (1), further including
an amplifier that amplifies a signal received via an antenna, in which
the wireless communication unit transmits position information obtained by the positioning processing unit, and
the control unit controls an operation of the amplifier on the basis of control information regarding the positioning processing obtained via the wireless communication unit.

(3) The wireless communication terminal according to (2), in which
the wireless communication unit transmits reception strength together with position information obtained by the positioning processing unit.

(4) The wireless communication terminal according to (2) or (3), in which
the control information includes a signal for turning on or off the amplifier.

(5) The wireless communication terminal according to any one of (1) to (4), in which
the wireless communication unit includes:
a first wireless communication unit that performs wireless communication related to the positioning processing; and
a second wireless communication unit that performs wireless communication related to control of the power consumption.

(6) The wireless communication terminal according to (5), in which
the first wireless communication unit performs wireless communication using a global navigation satellite system (GNSS), and
the second wireless communication unit performs wireless communication using at least one of low power wide area (LPWA), WiFi, BlueTooth, Bluetooth low energy (BLE), or cellular communication.

(7) The wireless communication terminal according to any one of (1) to (6), in which
the positioning processing unit performs positioning processing on the basis of a signal using at least one of GNSS, LPWA, WiFi, BlueTooth, BLE, cellular communication, received signal strength, or an arrival angle.

(8) The wireless communication terminal according to any one of (1) to (7), in which
the control information includes information regarding position accuracy setting.

(9) The wireless communication terminal according to (8), in which
the control unit sets an operation of the positioning processing unit to on or off on the basis of the information regarding the position accuracy setting.

(10) The wireless communication terminal according to (8) or (9), in which
the position accuracy is set on the basis of at least one of external designation, scheduling, position information, an application, or a contract form.

(11) A base station including:
a wireless communication unit that performs wireless communication; and
a communication processing unit that performs communication processing of control information for controlling power consumption related to positioning processing.

(12) The base station according to (11), further including:
a reception strength prediction unit that predicts reception strength around the communication destination on the basis of position information of a communication destination; and
a first control information generation unit that generates the control information on the basis of the reception strength around the communication destination.

(13) The base station according to (12), further including
a table indicating a relationship between position information of the communication destination and reception strength around the communication destination.

(14) The base station according to any one of (11) to (13), in which
the wireless communication unit performs wireless communication using at least one of LPWA, WiFi, BlueTooth, BLE, or cellular communication.

(15) The base station according to any one of (11) to (14), further including:
a position accuracy setting unit that sets position accuracy of a communication destination; and
a second control information generation unit that generates the control information on the basis of position accuracy setting of the communication destination.

(16) The base station according to (15), in which
the position accuracy setting unit sets the position accuracy on the basis of at least one of external designation, scheduling, position information, an application, or a contract form.

(17) A wireless communication system including:
a base station that transmits control information for controlling power consumption related to positioning processing; and
a wireless communication terminal that controls power consumption related to the positioning processing on the basis of the control information transmitted from the base station.

(18) The wireless communication system according to (17), in which
the base station
predicts reception strength around the wireless communication terminal on the basis of position information of the wireless communication terminal,
generates control information for controlling power consumption related to positioning processing of the wireless communication terminal on the basis of reception strength around the wireless communication terminal, and
transmits the generated control information to the wireless communication terminal, and
the wireless communication terminal
receives the control information transmitted from the base station, and
controls an operation of an amplifier for amplifying reception data related to the positioning processing on the basis of the control information.

(19) The wireless communication system according to (17) or (18), in which
the base station
sets position accuracy of the wireless communication terminal,
generates control information for controlling power consumption related to positioning processing of the wireless communication terminal on the basis of position accuracy setting of the wireless communication terminal, and
transmits the generated control information to the wireless communication terminal, and
the wireless communication terminal
transmits position information of the wireless communication terminal to the base station,
receives the control information transmitted from the base station, and
sets an operation of the positioning processing to on or off on the basis of the control information.

(20) The wireless communication system according to any one of (17) to (19), in which
the wireless communication terminal performs wireless communication using GNSS, and
the wireless communication terminal and the base station perform wireless communication using at least one of LPWA, WiFi, BlueTooth, BLE, or cellular communication.

### REFERENCE SIGNS LIST

101 Wireless communication terminal
102 Base station
103 GNSS satellite
111, 121 Antenna
131 Amplifier
141, 161, 112 Wireless communication unit
151 Positioning processing unit
171 Control unit
122 Communication processing unit
132 Reception strength prediction unit
142 Table
152 Control information generation unit

1. A wireless communication terminal comprising:
a wireless communication unit that performs wireless communication;
a positioning processing unit that performs positioning processing on a basis of reception data received via the wireless communication unit; and
a control unit that controls power consumption related to the positioning processing on a basis of control information regarding the positioning processing acquired via the wireless communication unit.

2. The wireless communication terminal according to claim 1, further comprising
an amplifier that amplifies a signal received via an antenna, wherein
the wireless communication unit transmits position information obtained by the positioning processing unit, and
the control unit controls an operation of the amplifier on a basis of control information regarding the positioning processing obtained via the wireless communication unit.

3. The wireless communication terminal according to claim 1, wherein
the wireless communication unit transmits reception strength together with position information obtained by the positioning processing unit.

4. The wireless communication terminal according to claim 2, wherein
the control information includes a signal for turning on or off the amplifier.

5. The wireless communication terminal according to claim 1, wherein
the wireless communication unit includes:
a first wireless communication unit that performs wireless communication related to the positioning processing; and
a second wireless communication unit that performs wireless communication related to control of the power consumption.

6. The wireless communication terminal according to claim 5, wherein
the first wireless communication unit performs wireless communication using a global navigation satellite system (GNSS), and
the second wireless communication unit performs wireless communication using at least one of low power wide area (LPWA), WiFi, BlueTooth, Bluetooth low energy (BLE), or cellular communication.

7. The wireless communication terminal according to claim 1, wherein
the positioning processing unit performs positioning processing on a basis of a signal using at least one of GNSS, LPWA, WiFi, BlueTooth, BLE, cellular communication, received signal strength, or an arrival angle.

8. The wireless communication terminal according to claim 1, wherein
the control information includes information regarding position accuracy setting.

9. The wireless communication terminal according to claim 8, wherein
the control unit sets an operation of the positioning processing unit to on or off on a basis of the information regarding the position accuracy setting.

10. The wireless communication terminal according to claim 1, wherein
the position accuracy is set on a basis of at least one of external designation, scheduling, position information, an application, or a contract form.

11. A base station comprising:
a wireless communication unit that performs wireless communication; and
a communication processing unit that performs communication processing of control information for controlling power consumption related to positioning processing.

12. The base station according to claim 11, further comprising:
a reception strength prediction unit that predicts reception strength around a communication destination on a basis of position information of the communication destination; and
a first control information generation unit that generates the control information on a basis of the reception strength around the communication destination.

13. The base station according to claim 12, further comprising
a table indicating a relationship between position information of the communication destination and reception strength around the communication destination.

14. The base station according to claim 11, wherein
the wireless communication unit performs wireless communication using at least one of LPWA, WiFi, BlueTooth, BLE, or cellular communication.

15. The base station according to claim 11, further comprising:
a position accuracy setting unit that sets position accuracy of a communication destination; and
a second control information generation unit that generates the control information on a basis of position accuracy setting of the communication destination.

16. The base station according to claim 15, wherein
the position accuracy setting unit sets the position accuracy on a basis of at least one of external designation, scheduling, position information, an application, or a contract form.

17. A wireless communication system comprising:
a base station that transmits control information for controlling power consumption related to positioning processing; and
a wireless communication terminal that controls power consumption related to the positioning processing on a basis of the control information transmitted from the base station.

18. The wireless communication system according to claim 17, wherein
the base station
predicts reception strength around the wireless communication terminal on a basis of position information of the wireless communication terminal,
generates control information for controlling power consumption related to positioning processing of the wireless communication terminal on a basis of reception strength around the wireless communication terminal, and
transmits the generated control information to the wireless communication terminal, and
the wireless communication terminal
transmits position information of the wireless communication terminal to the base station,
receives the control information transmitted from the base station, and
controls an operation of an amplifier for amplifying reception data related to the positioning processing on a basis of the control information.

19. The wireless communication system according to claim 17, wherein
the base station
sets position accuracy of the wireless communication terminal,
generates control information for controlling power consumption related to positioning processing of the wireless communication terminal on a basis of position accuracy setting of the wireless communication terminal, and
transmits the generated control information to the wireless communication terminal, and
the wireless communication terminal
receives the control information transmitted from the base station, and
sets an operation of the positioning processing to on or off on a basis of the control information.

20. The wireless communication system according to claim 17, wherein
the wireless communication terminal performs wireless communication using GNSS, and
the wireless communication terminal and the base station perform wireless communication using at least one of LPWA, WiFi, BlueTooth, BLE, or cellular communication.
